(19) United States
(12) Patent Application Publication
(10) Pub. No.: US 2017/0347292 A1
(43) Pub. Date: Nov. 30, 2017

(54) BASE STATION CENTRAL CONTROL SERVER AND BASE STATION OUTAGE COMPENSATION METHOD THEREOF

(71) Applicant: Institute For Information Industry, Taipei (TW)

(72) Inventors: Chih-Hsiang HO, Taipei City (TW); Li-Sheng CHEN, Yilan City (TW); Wei-Ho CHUNG, Taipei City (TW); Sy-Yen KUO, Taipei City (TW)

(21) Appl. No.: 15/371,187

(22) Filed: Dec. 6, 2016

Related U.S. Application Data
(60) Provisional application No. 62/340,589, filed on May 24, 2016.

(51) Int. Cl. H04W 28/08; H04W 16/28; H04W 24/02; H04W 36/22

(52) U.S. Cl. CPC H04W 28/08; H04W 36/22; H04W 16/28; H04W 24/02

(57) ABSTRACT

A base station central control server and a base station outage compensation method thereof are provided. After detecting an outage of a first base station, the base station central control server calculates a plurality of compensation indices which correspond to a plurality of second base stations according to base station information of the second base stations, and selects a prior compensation index which corresponds to a third base station. The base station central control server selects a main compensation configuration from a plurality of compensation configurations of the third base station, and notifies the third base station of performing compensation communication based on the main compensation configuration.

### PRIORITY

This application claims priority to U.S. Provisional Patent Application No. 62/340,589 filed on May 24, 2016, which is hereby incorporated by reference in its entirety.

### FIELD

The present invention relates to a base station central control server and a base station outage compensation method thereof; and more particularly, the base station central control server and the base station outage compensation method thereof according to the present invention take a plurality of parameters into consideration to select a preferred base station and select a preferred mode in this base station to perform outage compensation.

### BACKGROUND

The conventional network architecture usually has a plurality of base stations distributed in an area to provide network services to a plurality of user equipment within the area. However, in case of an outage of any of the base stations due to hardware or software abnormality, user equipment originally served by this base station will no longer be covered by the communication coverage of this base station and will become unable to receive data in the network correctly. This leads to degradation in service quality of the overall network and in the communication coverage rate.

To solve the aforesaid problems, related outage detection and handling mechanisms have been developed. However, in the conventional outage handling technologies, a base station is selected by considering only load statuses of adjacent base stations without taking other potential factors into consideration. Moreover, instead of evaluating multiple schemes simultaneously, most of the conventional technologies adopt only a single handling mechanism (e.g., adjusting the antenna configuration of adjacent base stations) after the base station has been selected. Obviously, the conventional outage handling technologies cannot provide a satisfactory efficiency and the effects thereof are not so significant.

Accordingly, an urgent need exists in the art to make an improvement on the shortcomings of the conventional outage handling mechanism.

### SUMMARY

The disclosure includes a base station outage compensation method for a base station central control server. The base station central control server connects to a plurality of base stations including a first base station and a plurality of second base stations. The base station outage compensation method can comprise: (a) enabling the base station central control server to detect an outage of the first base station; (b) enabling the base station central control server to calculate a plurality of compensation indices corresponding to the second base stations according to a plurality of pieces of base station information of the second base stations after the step (a); (c) enabling the base station central control server to select a prior compensation index from the compensation indices, wherein the prior compensation index corresponds to a third base station among the second base stations; (d) enabling the base station central control server to select a main compensation configuration from a plurality of compensation configurations of the third base station; and (e) enabling the base station central control server to notify the third base station of performing compensation communication based on the main compensation configuration.

The disclosure also includes a base station central control server, which comprises a transceiving interface and a processing unit. The transceiving interface is configured to connect with a plurality of base stations including a first base station and a plurality of second base stations. The processing unit is electrically connected to the transceiving interface and configured to: detect an outage of the first base station; calculate a plurality of compensation indices corresponding to the second base stations according to a plurality of pieces of base station information of the second base stations; select a prior compensation index from the compensation indices, wherein the prior compensation index corresponds to a third base station among the second base stations; select a main compensation configuration from a plurality of compensation configurations of the third base station; and notify via the transceiving interface the third base station of performing compensation communication based on the main compensation configuration.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIGS. 1A-1B are schematic views illustrating operations of a base station central control server according to a first embodiment of the present invention;

FIG. 1C is a block diagram of the base station central control server according to the first embodiment of the present invention;

FIGS. 2A-2B are schematic views illustrating operations of a base station central control server according to a second embodiment of the present invention;

FIG. 2C is a block diagram of the base station central control server according to the second embodiment of the present invention;

FIG. 3 is a flowchart diagram of a base station outage compensation method according to a third embodiment of the present invention; and

FIG. 4 is a flowchart diagram of a base station outage compensation method according to a fourth embodiment of the present invention.

### DETAILED DESCRIPTION

In the following description, the present invention will be explained with reference to example embodiments thereof. However, these example embodiments are not intended to limit the present invention to any specific examples, embodiments, environment, applications or particular implementations described in these example embodiments. Therefore, description of these example embodiments is only for purpose of illustration rather than to limit the present invention.

It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

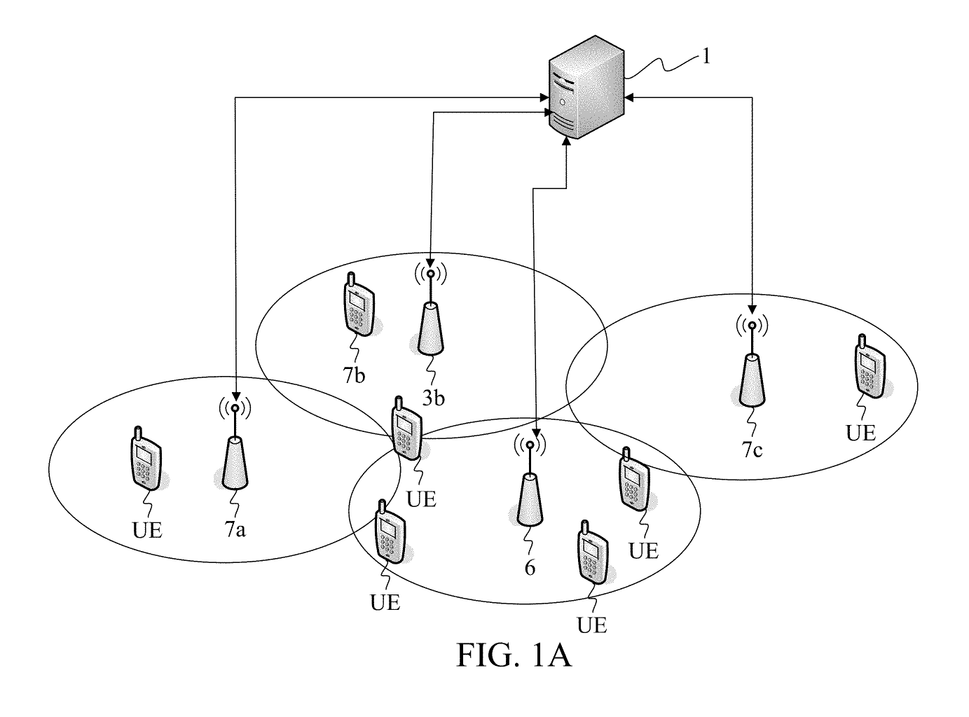

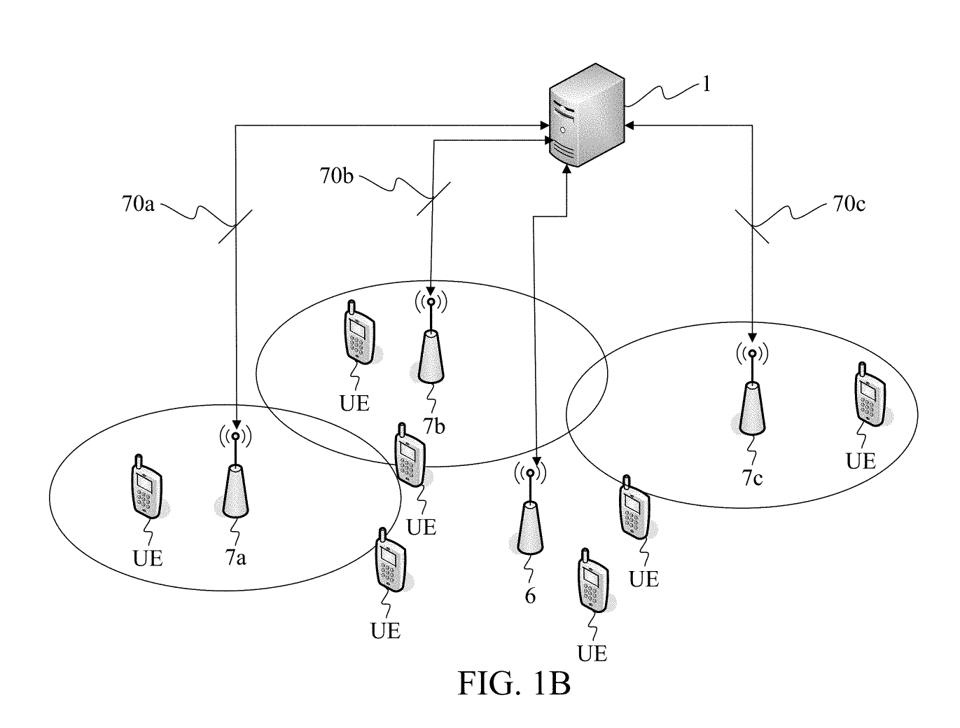

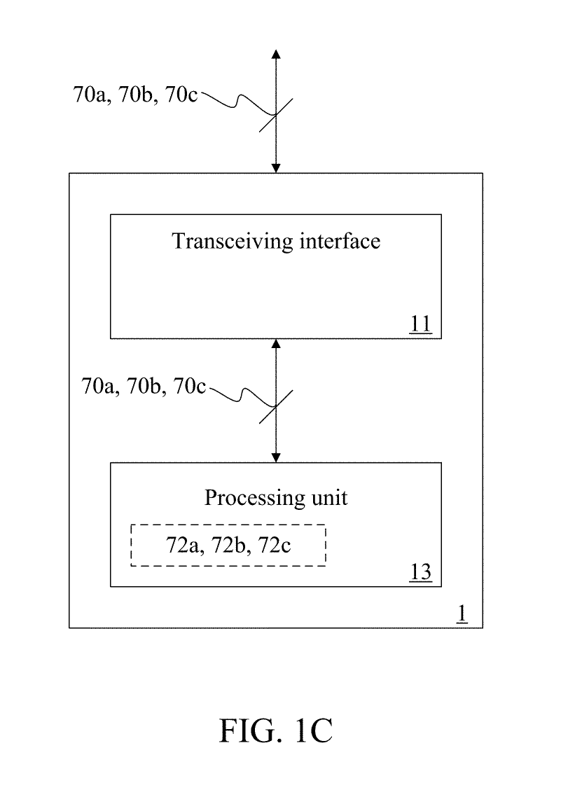

Please refer to FIGS. 1A-1C. FIGS. 1A-1B are schematic views illustrating operations of a base station central control server 1 according to a first embodiment of the present invention, and FIG. 1C is a block diagram of the base station central control server 1 according to the first embodiment of the present invention. The base station central control server 1 comprises a transceiving interface 11 and a processing unit 13 electrically connected with each other. The operational process of the base station central control server 1 will be further described herein below.

First, the transceiving interface 11 of the base station central control server 1 connects to a plurality of base stations to receive a plurality of pieces of base station information from the base stations and to centrally manage the base stations accordingly. As shown, the base stations include a first base station 6 and a plurality of second base stations 7a˜7c, and each base station serves a plurality of user equipment communicating with the base station within the communication coverage thereof (within the elliptical solid lines as shown in FIG. 1A). Please refer to FIG. 1B next. In case of an outage of the first base station 6 due to hardware or software abnormality, the first base station 6 becomes unable to continue to serve the user equipment that it originally served. Then the outage of the first base station 6 is detected by the processing unit 13 of the base station central control server 1 via the transceiving interface 11.

It shall be appreciated that, the processing unit 13 of the base station central control server 1 may determine that an outage takes place to the first base station 6 when it fails to receive any message from the first base station 6 within a certain time period or when it has transmitted an ACK signal but receives no response to the ACK signal. However, this is not intended to limit the implementations of detecting the outage.

Then, the base station central control server 1 must determine how to compensate for the outage of the first base station 6 according to related information of base stations adjacent to the first base station 6. Specifically, because the base station central control server 1 has related information (e.g., location information) of all base stations, the processing unit 13 of the base station central control server 1 can determine base stations (i.e., second base stations 7a˜7c) adjacent to the first base station 6 and calculate a plurality of compensation indices 72a˜72c corresponding to the second base stations 7a˜7c according to a plurality of pieces of base station information 70a˜70c of the second base stations 7a˜7c.

Next, the processing unit 13 of the base station central control server 1 selects a prior compensation index from the compensation indices 72a˜72c. In the first embodiment, the prior compensation index is the compensation index 72a. Because the selected compensation index 72a corresponds to the second base station 7a, the processing unit 13 of the base station central control server 1 selects a main compensation configuration from a plurality of compensation configurations (not shown) transmitted back by the second base station 7a, and via the transceiving interface 11, notifies the second base station 7a of performing the compensation communication based on the main compensation configuration.

Thereby, the base station central control server of the present invention can select an appropriate base station according to compensation indices of different base stations, select an appropriate compensation mechanism from a plurality of compensation configurations of the selected base station, and notify the selected base station of performing the compensation communication for the base station experiencing the outage.

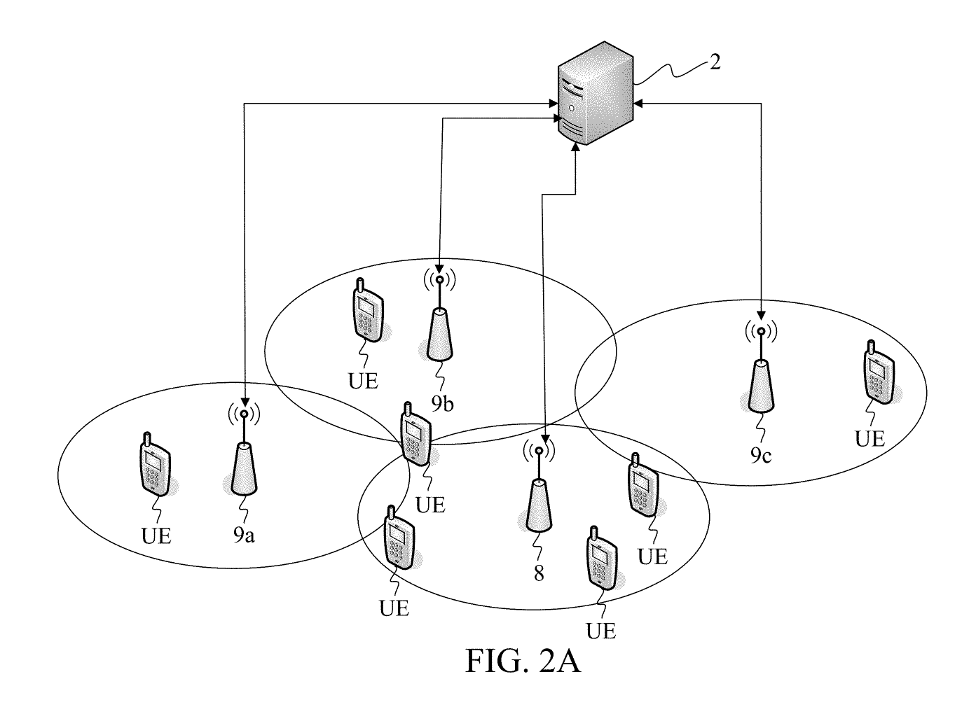

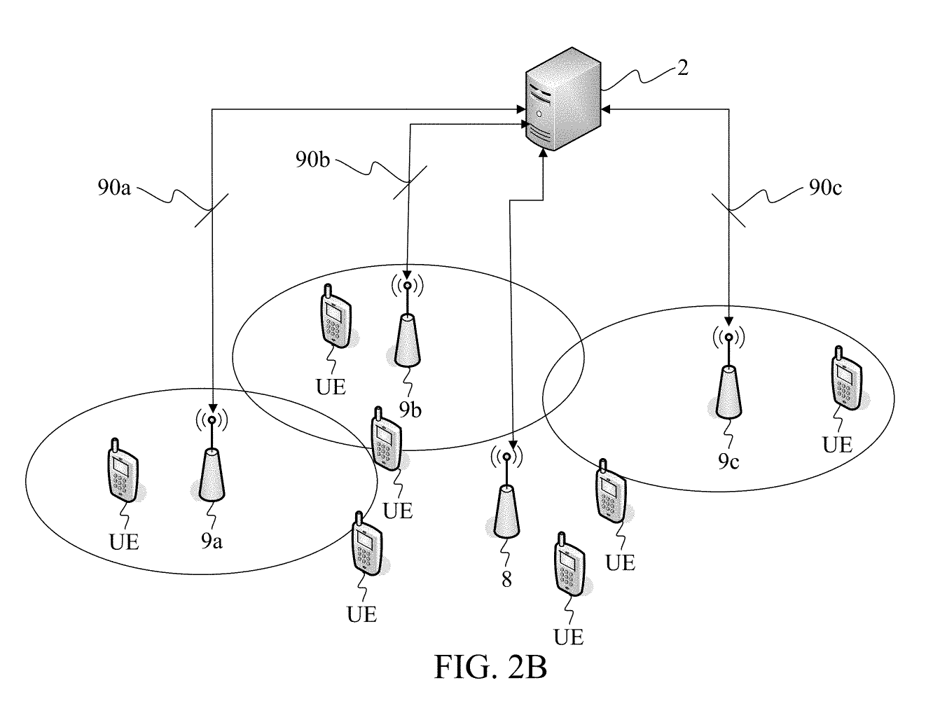

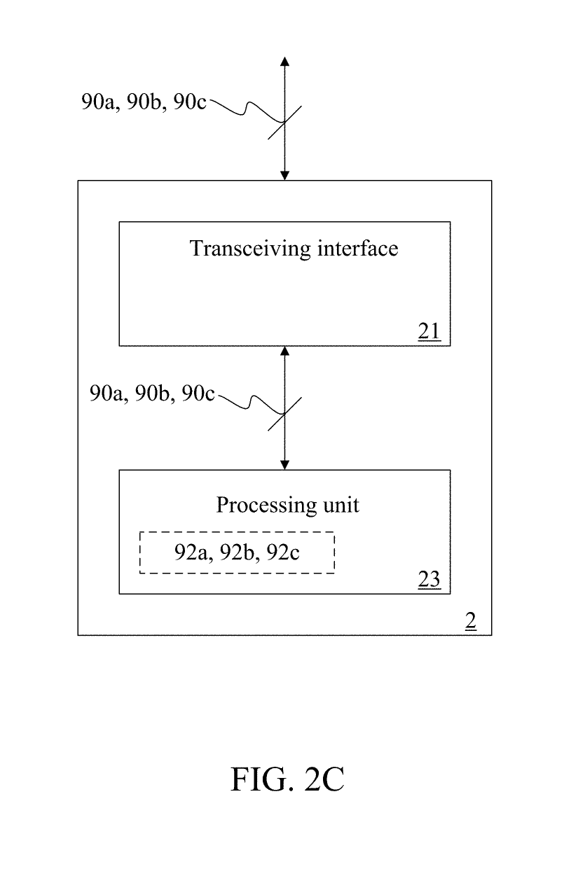

Please refer to FIGS. 2A-2C. FIGS. 2A-2B are schematic views illustrating operations of a base station central control server 2 according to a second embodiment of the present invention, and FIG. 2C is a block diagram of the base station central control server 2 according to the second embodiment of the present invention. The base station central control server 2 comprises a transceiving interface 21 and a processing unit 23 electrically connected with each other. The second embodiment is mainly intended to further illustrate detailed operations of the base station central control server.

First, the transceiving interface 21 of the base station central control server 2 connects to a plurality of base stations to receive a plurality of pieces of base station information from the base stations and to centrally manage the base stations accordingly. As shown, the base stations include a first base station 8 and a plurality of second base stations 9a˜9c, and each base station serves a plurality of user equipment communicating with the base station within the communication coverage thereof (within the elliptical solid lines as shown in FIG. 2A).

Please refer to FIG. 2B next. In case of an outage of the first base station 8 due to hardware or software abnormality, the first base station 8 becomes unable to continue to serve the user equipment that it originally served. Then the outage of the first base station 8 is detected by the processing unit 23 of the base station central control server 2 via the transceiving interface 21.

Then, the base station central control server 2 must determine how to compensate for the outage of the first base station 8 according to related information of base stations adjacent to the first base station 8. Specifically, because the base station central control server 2 has related information (e.g., location information) of all base stations, the processing unit 23 of the base station central control server 2 can determine base stations (i.e., second base stations 9a˜9c) adjacent to the first base station 8 and calculate a plurality of compensation indices 92a˜92c corresponding to the second base stations 9a˜9c according to a plurality of pieces of base station information 90a˜90c of the second base stations 9a˜9c.

Further speaking, each of the compensation indices comprises a compensable user equipment number, a load indicator and an interference indicator. In the second embodiment, the compensation indices 92a˜92c of the second base stations 9a˜9c are as listed in the following table:

| | Compensable user | Load | Interference |
|---|---|---|---|
| Base station | equipment number | indicator | indicator |
| 9a | 2 | 2 | 1 |
| 9b | 1 | 4 | 1 |
| 9c | 1 | 5 | 4 |

Taking the second base station 9a as an example, the compensable user equipment number is the number of compensable user equipment that cannot be served by the first base station 8, which is estimated according to measurement of the network environment. The load indicator represents a resource block utilization ratio of the second base station 9a, and a greater value of the load indicator represents a higher resource block utilization ratio (i.e., a higher load).

The interference indicator represents an interference quantization value of the second base station 9a, and similarly, a greater value of the interference indicator represents larger interference experienced by the second base station 9a. For example, for each user equipment connecting to the second base station 9a within the communication coverage, the second base station 9a may determine whether the current interfered average signal quality minus a previous interfered average signal quality of the user equipment is greater than a threshold value, and takes the number of user equipment of which the determination result is “No” as the interference indicator.

It shall be particularly appreciated that, the present invention focuses on how to select an appropriate base station according to different parameters, and how to detect the compensable user equipment number and obtain and use the load indicator and the interference indicator can be readily understood by those skilled in the art, so this will not be further described.

Then, the processing unit 23 of the base station central control server 2 can calculate the compensation indices 92a˜92c of the second base stations 9a˜9c according to the following formula:

$$ϑ = {α}_{1} \cdot u + {β}_{1} \cdot \frac{1}{l} + {γ}_{1} \cdot \frac{1}{n}$$

where θ is the compensation index, u is the compensable user equipment number, l is the load indicator, n is the interference indicator.

It shall be particularly appreciated that, because the operational needs vary with different network environments, the backend operator (e.g., telecommunication operators) may use weight values to adjust importances of the compensable user equipment number, the load indicator and the interference indicator for compensation indices depending on practical needs. In this formula, α₁ is a first weight value, β₁ is a second weight value, γ₁ is a third weight value, and α₁+β₁+γ₁=1.

Accordingly, the backend operator may increase the value of α₁ if he thinks that the compensable user equipment number is a more important consideration factor. On the other hand, the backend operator may increase the value of β₁ if he thinks that whether the load of the base station is excessive is a more important consideration factor. Likewise, the backend operator may increase the value of γ₁ if he thinks that whether the interference experienced by the base station is serious is a more important consideration factor.

In the second embodiment, α₁, β₁, γ₁ are 0.5, 0.3, 0.2 respectively, so the

92a=0.5·2+0.3·½+0.2· 1/1=1.35

92b=0.5·1+0.3·¼+0.2· 1/1=0.775

92c=0.5·1+0.3·⅕+0.2·¼=0.61

Because a larger compensation index value of a base station means that the base station generally has a larger compensable user equipment number, a lower load and lower interference, the processing unit 23 of the base station central control server 2 selects a prior compensation index having a larger value from the compensation indices 92a˜92c and takes a base station corresponding to the selected prior compensation index as the base station for compensation.

In the second embodiment, the prior compensation index is the compensation index 92a, so the base station for performing subsequent compensation operations is the second base station 9a. Because the second base station 9a has a plurality of compensation strategies, the base station central control server 2 must select a main compensation configuration from a plurality of compensation configurations (not shown) transmitted back by the second base station 9a.

In detail, the plurality of compensation configurations include an antenna angle configuration, a transmission power configuration and a handover base station re-selection parameter adjustment configuration in the second embodiment. The antenna angle configuration mainly adopts adjusting the receive angle of the antenna as a compensation strategy, the transmission power configuration mainly adopts adjusting the transmission power of the base station as a compensation strategy, and the handover base station re-selection parameter adjustment configuration mainly adopts adjusting the base station handover re-selection parameter as a compensation strategy.

Next, the processing unit 23 of the base station central control server 2 calculates a benefit-to-cost ratio of each configuration. Specifically, the processing unit 23 first calculates a benefit value of each configuration according to the following formula:

ε=α₂·d+β₂·s+γ₂·c

where ε is the configuration benefit value, d is an estimated average data transmission rate of compensable user equipment, s is an estimated average data transmission rate of all the user equipment after the compensation, c is an estimated compensable communication range quantization value after the compensation.

Taking the antenna angle configuration as an example, the estimated average data transmission rate of compensable user equipment is an average transmission rate of all compensable user equipment estimated by the second base station 9a after the antenna angle is adjusted; the estimated average data transmission rate of all the user equipment after the compensation is an average transmission rate of all user equipment that can be served (including user equipment that were originally served and that are compensated) estimated by the second base station 9a after the antenna angle is adjusted; and the compensable communication range quantization value after the compensation is a quantization area value of an increased communication coverage of the second base station 9a after the antenna angle is adjusted.

It shall be appreciated that, because different compensation strategies have different limitations in use, weight values may be used to adjust importances of the estimated average data transmission rate of compensable user equipment, the estimated average data transmission rate of all the user equipment after the compensation and the estimated compensable communication range quantization value after the compensation depending on the user's needs. In the formula, α₂ is a fourth weight value, β₂ is a fifth weight value, γ₂ is a sixth weight value, and α₂+β₂+γ₂=1.

It shall be emphasized again that, the present invention mainly focuses on how to select an appropriate configuration for compensation from the base station, and calculation of the estimated average data transmission rate of compensable user equipment, the estimated average data transmission rate of all the user equipment after the compensation and the estimated compensable communication range quantization value after the compensation can be readily known by those of ordinary skill in the art from the above description, so this will not be further described herein.

In the second embodiment, benefit-related contents of each compensation configuration are as shown in the following table:

| | Average data | Average data | Compensable |
|---|---|---|---|
| | transmission rate | transmission rate | communication |
| | of compensable user | of all the user | range quan- |
| Configuration | equipment | equipment | tization value |
| Antenna | 6 | 4 | 2 |
| angle | | | |
| Transmission | 5 | 3 | 2 |
| power | | | |
| Handover | 3 | 3 | 0 |
| re-selection | | | |

In the second embodiment, α₂, β₂, γ₂ are 0.4, 0.4, 0.2 respectively, so the configuration benefit values of the antenna configuration, the transmission power configuration and the handover base station re-selection parameter adjustment configuration are:
Benefit value of the antenna configuration=0.4·6+0.4·4+0.2·2=4.4
Benefit value of the transmission power configuration=0.4·5+0.4·3+0.2·2=3.6
Benefit value of handover base station re-selection parameter adjustment configuration=0.4·3+0.4·3+0.2·0=2.4.

On the other hand, the processing unit 23 calculates a cost value of each configuration according to the following formula:

φ=α₃·t+β₃·o+γ₃·e

where φ is the configuration cost value, t is an estimated time cost value of the compensation, o is an estimated resource cost value of the compensation, e is an estimated power cost value of the compensation.

Similarly, taking the antenna angle configuration as an example, the estimated time cost value of the compensation is the time quantization value necessary for adjusting the antenna angle; the estimated resource cost value of the compensation is the resource (human resources, and device hardware resource) quantization value necessary for adjusting the antenna angle; and the estimated power cost value of the compensation is a power quantization value necessary for adjusting the antenna angle.

Similarly, it shall be appreciated that, because different compensation strategies have different limitations in use, weight values may be used to adjust importances of the estimated time cost value of the compensation, the estimated resource cost value of the compensation and the estimated power cost value of the compensation for the configuration cost value depending on the user's needs. In the formula, α₃ is a seventh weight value, β₃ is an eighth, γ₃ is a ninth weight value, and α₃+β₃+γ₃=1.

It shall also be emphasized again that, the present invention mainly focuses on how to select an appropriate configuration for compensation from the base station, and calculation of the estimated time cost value of the compensation, the estimated resource cost value of the compensation and the estimated power cost value of the compensation can be readily known by those of ordinary skill in the art from the above description, so this will not be further described herein.

In the second embodiment, cost-related contents of each compensation configuration are as shown in the following table:

| | Time | Resource | Power |
|---|---|---|---|
| Configuration | cost value | cost value | cost value |
| Antenna | 1 | 3 | 2 |
| angle | | | |
| Transmission | 1 | 2 | 4 |
| power | | | |
| Handover | 2 | 2 | 2 |
| re-selection | | | |

In the second embodiment, α₃, β₃, γ₃ are 0.4, 0.3, 0.3 respectively, so the configuration cost values of the antenna angle configuration, the transmission power configuration and the handover base station re-selection parameter adjustment configuration are:
Cost value of the antenna configuration=0.4·1+0.3·3+0.3·2=1.9
Cost value of the transmission power configuration=0.4·1+0.3·2+0.3·4=2.2
Cost value of handover base station re-selection parameter adjustment configuration=0.4·2+0.3·2+0.3·2=2.

Accordingly, the processing unit 23 can calculate corresponding configuration benefit-to-cost ratios according to respective configuration benefit values and configuration cost values of the antenna angle configuration, the transmission power configuration and the handover base station re-selection parameter adjustment configuration as follows:
Benefit-to-cost ratio of the antenna angle configuration=4.4/1.9=2.135
Benefit-to-cost ratio of the transmission power configuration=3.6/2.2=1.636
Benefit-to-cost ratio of the handover base station re-selection parameter adjustment configuration=2.4/2=1.2

Thereafter, the processing unit 23 selects a main compensation configuration that has the greatest benefit-to-cost ratio from the compensation configurations of the second base station 9a. Because the antenna angle configuration has the greatest benefit-to-cost ratio in the second embodiment, the main compensation configuration is just the antenna angle configuration. Finally, the processing unit 23 notifies via the transceiving interface 21 the second base station 9a of performing the compensation communication based on the main compensation configuration, i.e., notifies the second base station 9a of performing the compensation communication for the user equipment by adjusting the antenna angle.

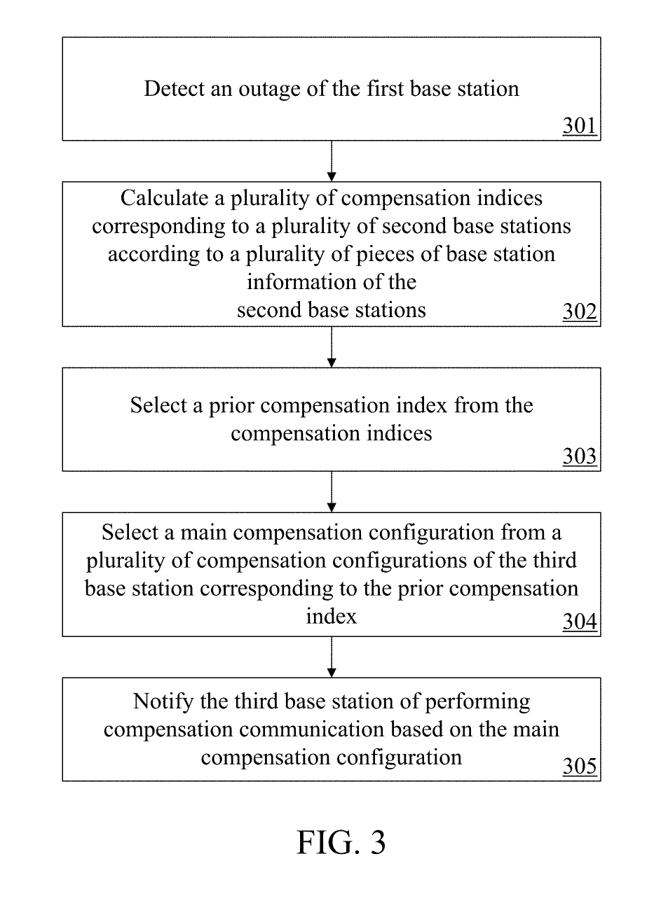

A third embodiment of the present invention is a base station outage compensation method, a flowchart diagram of which is shown in FIG. 3. The method of the third embodiment is for use in a base station central control server (e.g., the base station central control server 1 of the aforesaid embodiment). The base station central control server connects to a plurality of base stations including a first base station and a plurality of second base stations. Detailed steps of the third embodiment are described as follows.

First, step 301 is executed to enable the base station central control server to detect an outage of the first base station. Step 302 is executed to enable the base station central control server to calculate a plurality of compensation indices corresponding to the second base stations according to a plurality of pieces of base station information of the second base stations after the step 301.

Then, step 303 is executed to enable the base station central control server to select a prior compensation index from the compensation indices. The prior compensation index corresponds to a third base station among the second base stations. Step 304 is executed to enable the base station central control server to select a main compensation configuration from a plurality of compensation configurations of the third base station. Finally, step 305 is executed to enable the base station central control server to notify the third base station of performing compensation communication based on the main compensation configuration.

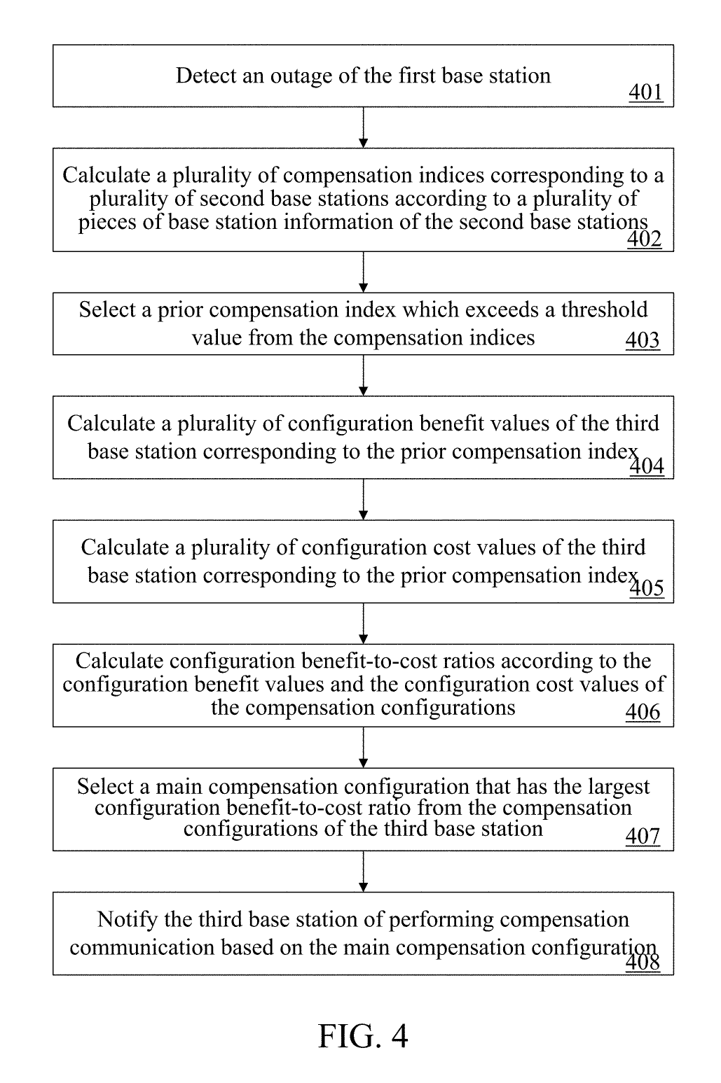

A fourth embodiment of the present invention is a base station outage compensation method, a flowchart diagram of which is shown in FIG. 4. The method of the third embodiment is for use in a base station central control server (e.g., the base station central control server 2 of the aforesaid embodiment). The base station central control server connects to a plurality of base stations including a first base station and a plurality of second base stations. Detailed steps of the fourth embodiment are described as follows.

First, step 401 is executed to enable the base station central control server to detect an outage of the first base station. Step 402 is executed to enable the base station central control server to calculate a plurality of compensation indices corresponding to the second base stations according to a plurality of pieces of base station information of the second base stations after the step 401. The compensation indices are calculated mainly according to the following formula:

$$ϑ = {α}_{1} \cdot u + {β}_{1} \cdot \frac{1}{l} + {γ}_{1} \cdot \frac{1}{n}$$

It shall be appreciated that, θ is the compensation index, u is the compensable user equipment number, l is the load indicator, n is the interference indicator, α₁ is a first weight value, β₁ is a second weight value, γ₁ is a third weight value, and α₁+β₁+γ₁=1. The load indicator represents a resource block utilization ratio of the corresponding second base station, and the inference indicator represents an interference quantization value of the corresponding second base station.

Next, step 403 is executed to enable the base station central control server to select a prior compensation index which exceeds a threshold value from the compensation indices. The prior compensation index corresponds to a third base station among the second base stations. Step 404 is executed to enable the base station central control server to calculate a plurality of configuration benefit values of the third base station according to the following formula:

ε=α₂·d+β₂·s+γ₂·c

It shall be appreciated that, the threshold value may be adjusted by the user himself depending on the network environment, ε is the configuration benefit value, d is an estimated average data transmission rate of compensable user equipment, s is an estimated average data transmission rate of all the user equipment after the compensation, c is an estimated compensable communication range quantization value after the compensation, α₂ is a fourth weight value, β₂ is a fifth weight value, γ₂ is a sixth weight value, and α₂+β₂+γ₂=1.

Subsequently, step 405 is executed to enable the base station central control server to calculate a plurality of configuration cost values of the third base station according to the following formula:

φ=α₃·t+β₃·o+γ₃·e

It shall also be appreciated that, φ is the configuration cost value, t is an estimated time cost value of the compensation, o is an estimated resource cost value of the compensation, e is an estimated power cost value of the compensation, α₃ is a seventh weight value, β₃ is an eighth weight value, γ₃ is a ninth weight value, and α₃+β₃+γ₃=1.

Accordingly, step 406 is executed to enable the base station central control server to calculate configuration benefit-to-cost ratios according to the configuration benefit values and the configuration cost values of the compensation configurations. Step 407 is executed to enable the base station central control server to select a main compensation configuration that has the largest configuration benefit-to-cost ratio from the compensation configurations of the third base station. Finally, step 408 is executed to enable the base station central control server to notify the third base station of performing compensation communication based on the main compensation configuration.

According to the above descriptions, the base station central control server and the base station outage compensation method thereof according to the present invention may first select an appropriate base station according to compensation indices of different base stations. After the appropriate base station is selected, the base station central control server may calculate benefit-to-cost ratios of a plurality of compensation configurations of the selected base station and selects a compensation configuration having the largest benefit-to-cost ratio from the compensation configurations. Finally, the base station central control server notifies the selected base station of performing communication compensation for the base station experiencing the outage according to the compensation configuration having the largest benefit-to-cost ratio. In this way, improvement can be effectively made on the shortcoming of the prior art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A base station outage compensation method for a base station central control server, the base station central control server connecting to a plurality of base stations including a first base station and a plurality of second base stations, the base station outage compensation method comprising:
(a) the base station central control server detecting an outage of the first base station;
(b) the base station central control server calculating a plurality of compensation indices corresponding to the second base stations according to a plurality of pieces of base station information of the second base stations after the step (a);
(c) the base station central control server selecting a prior compensation index from the compensation indices, wherein the prior compensation index corresponds to a third base station among the second base stations;
(d) the base station central control server selecting a main compensation configuration from a plurality of compensation configurations of the third base station; and
(e) the base station central control server notifying the third base station of performing compensation communication based on the main compensation configuration.

2. The base station outage compensation method according to claim 1, wherein each of the plurality of pieces of base station information comprises a compensable user equipment number, a load indicator and an interference indicator of the corresponding second base station, the load indicator represents a resource block utilization ratio of the corresponding second base station, and the inference indicator represents an interference quantization value of the corresponding second base station.

3. The base station outage compensation method according to claim 2, wherein the step (b) further comprises:
(b1) the base station central control server calculating each of the compensation indices of each of the second base stations according to the following formula:
$$ϑ = α \cdot u + β \cdot \frac{1}{l} + γ \cdot \frac{1}{n}$$
where θ is the compensation index, u is the compensable user equipment number, l is the load indicator, n is the interference indicator, α is a first weight value, β is a second weight value, γ is a third weight value, and α+β+γ=1;
wherein the step (c) further comprises:
(c1) the base station central control server selecting the prior compensation index which exceeds a threshold value from the compensation indices.

4. The base station outage compensation method according to claim 1, wherein the compensation configurations include an antenna angle configuration, a transmission power configuration and a handover base station re-selection parameter adjustment configuration.

5. The base station outage compensation method according to claim 4, wherein the step (d) further comprises:
(d1) the base station central control server calculating a configuration benefit-to-cost ratio corresponding to each of the compensation configurations of the third base station according to each of the compensation configurations of the third base station, wherein the configuration benefit-to-cost ratio is a ratio of a configuration benefit value to a configuration cost value; and
(d2) the base station central control server selecting the main compensation configuration that has the largest configuration benefit-to-cost ratio from the compensation configurations of the third base station.

6. The base station outage compensation method according to claim 5, wherein the step (d1) further comprises:
(d11) the base station central control server calculating each of the configuration benefit values according to the following formula:
ε=α₁·d+β₁·s+γ₁·c
where ε is the configuration benefit value, d is an estimated average data transmission rate of compensable user equipment, s is an estimated average data transmission rate of all the user equipment after the compensation, c is an estimated compensable communication range quantization value after the compensation, α₁ is a first weight value, β₁ is a second weight value, γ₁ is a third weight value, and α₁+β₁+γ₁=1;
(d12) the base station central control server calculating each of the configuration cost values according to the following formula:
φ=α₂·t+β₂·o+γ₂·e
where φ is the configuration cost value, t is an estimated time cost value of the compensation, o is an estimated resource cost value of the compensation, e is an estimated power cost value of the compensation, α₂ is a fourth weight value, β₂ is a fifth weight value, γ₂ is a sixth weight value, and α₂+β₂+γ₂=1.

7. A base station central control server, comprising:
a transceiving interface, being configured to connect with a plurality of base stations including a first base station and a plurality of second base stations;
a processing unit electrically connected to the transceiving interface, being configured to:
detect an outage of the first base station;
calculate a plurality of compensation indices corresponding to the second base stations according to a plurality of pieces of base station information of the second base stations;
select a prior compensation index from the compensation indices, wherein the prior compensation index corresponds to a third base station among the second base stations;
select a main compensation configuration from a plurality of compensation configurations of the third base station; and
notify via the transceiving interface the third base station of performing compensation communication based on the main compensation configuration.

8. The base station central control server according to claim 7, wherein each of the plurality of pieces of base station information comprises a compensable user equipment number, a load indicator and an interference indicator of the corresponding second base station, the load indicator represents a resource block utilization ratio of the corresponding second base station, and the inference indicator represents an interference quantization value of the corresponding second base station.

9. The base station central control server according to claim 8, wherein the processing unit is further configured to:
calculate each of the compensation indices of each of the second base stations according to the following formula:
$$ϑ = α \cdot u + β \cdot \frac{1}{l} + γ \cdot \frac{1}{n}$$
where θ is the compensation index, u is the compensable user equipment number, l is the load indicator, n is the interference indicator, α is a first weight value, β is a second weight value, γ is a third weight value, and α+β+γ=1;
select the prior compensation index which exceeds a threshold value from the compensation indices.

10. The base station central control server according to claim 7, wherein the compensation configurations include an antenna angle configuration, a transmission power configuration and a handover base station re-selection parameter adjustment configuration.

11. The base station central control server according to claim 10, wherein the processing unit is further configured to:
calculate a configuration benefit-to-cost ratio corresponding to each of the compensation configurations of the third base station according to each of the compensation configurations of the third base station, wherein the configuration benefit-to-cost ratio is a ratio of a configuration benefit value to a configuration cost value; and
select the main compensation configuration that has the largest configuration benefit-to-cost ratio from the compensation configurations of the third base station.

12. The base station central control server according to claim 11, wherein the processing unit is further configured to:
calculate each of the configuration benefit values according to the following formula:
ε=α₁·d+β₁·s+γ₁·c
where ε is the configuration benefit value, d is an estimated average data transmission rate of compensable user equipment, s is an estimated average data transmission rate of all the user equipment after the compensation, c is an estimated compensable communication range quantization value after the compensation, α₁ is a first weight value, β₁ is a second weight value, γ₁ is a third weight value, and α₁+β₁+γ₁=1;
calculate each of the configuration cost values according to the following formula:
φ=α₂·t+β₂·o+γ₂·e
where φ is the configuration cost value, t is an estimated time cost value of the compensation, o is an estimated resource cost value of the compensation, e is an estimated power cost value of the compensation, α₂ is a fourth weight value, β₂ is a fifth weight value, γ₂ is a sixth weight value, and α₂+β₂+γ₂=1.
